(19) United States
(12) Patent Application Publication
(10) Pub. No.: US 2026/0038286 A1
(43) Pub. Date: Feb. 5, 2026

(54) METHOD AND SYSTEM FOR DIAGNOSING NASAL CYTOLOGY BASED ON DEEP LEARNING

(71) Applicants: Beijing Tongren Hospital, Capital Medical University, Beijing (CN); Beijing Institute of Otolaryngology, Beijing (CN)

(72) Inventors: Luo ZHANG, Beijing (CN); Yuan ZHANG, Beijing (CN); Jingyun LI, Beijing (CN); Chengshuo WANG, Beijing (CN); Xu ZHANG, Beijing (CN); Yu SONG, Beijing (CN)

(73) Assignees: Beijing Tongren Hospital, Capital Medical University, Beijing (CN); Beijing Institute of Otolaryngology, Beijing (CN)

(21) Appl. No.: 19/356,783

(22) Filed: Oct. 13, 2025

Related U.S. Application Data
(63) Continuation of application No. PCT/CN2024/115074, filed on Aug. 28, 2024.

(30) Foreign Application Priority Data
Aug. 9, 2024 (CN) 202411093815.9

(51) Int. Cl. G06V 20/69; G06V 10/32; G06V 10/44; G06V 10/80

(52) U.S. Cl. CPC G06V 20/698; G06V 10/32; G06V 10/454; G06V 10/806; G06V 20/695

(57) ABSTRACT

A method for diagnosing nasal cytology based on deep learning includes: reading in blocks a nasal cytology to be diagnosed in a sliding window; performing preprocessing on the window image and inputting the preprocessed window image into a trained cell detection model, a coordinate and a score of a bounding box of a detected target being obtained based on feature maps, and a bounding box set being obtained by filtering out bounding boxes with scores below a predetermined threshold; cropping an image from the window image based on coordinates of bounding boxes in the bounding box set, performing preprocessing on the image and inputting the preprocessed image into a trained cell classification model to output a cell category of the corresponding image, and performing post-processing to obtain a cell category of the nasal cytology to be diagnosed.

### CROSS-REFERENCE TO RELATED APPLICATIONS

This application is a continuation of International Patent Application No. PCT/CN2024/115074 with a filing date of Aug. 28, 2014, designating the United States, now pending, and further claims priority to Chinese Patent Application No. 202411093815.9 with a filing date of Aug. 9, 2024. The content of the aforementioned applications, including any intervening amendments thereto, are incorporated herein by reference.

### FIELD

The present disclosure relates to the technical field of nasal cytology diagnosis, and more particularly, to a method and system for diagnosing a nasal cytology based on deep learning.

### BACKGROUND

The traditional method for diagnosing nasal cytology mainly relies on doctors examining the types and quantities of various cells in nasal secretions under a microscope. Owing to the large number of cells, which may be as many as tens of thousands, doctors cannot accurately count the number of each type of cell. They rely only on experience and intuition, which leads to technical problems such as strong subjectivity and heavy dependence on doctors' experience. Moreover, because the cells are scattered on the smear and a single field of view of the microscope is limited, doctors need to constantly move the glass slide to view all cells. This may cause problems such as missing counts or repeated cell counts, and the diagnostic efficiency is low.

### SUMMARY

The present disclosure provides a method and system for diagnosing nasal cytology based on deep learning, aiming to solve the problems existing in the aforementioned prior art. The technical solutions include the following.

In an aspect, a method for diagnosing a nasal cytology based on deep learning is provided, including: S1, reading a nasal cytology in blocks to be diagnosed in a sliding window, and an image read within a window is referred to as a window image; S2, performing preprocessing on the window image; S3, inputting the preprocessed window image into a trained cell detection model, the cell detection model being configured to perform a series of feature extractions on the input preprocessed window image, enhance a pyramid feature map through bottom-up and top-down feature fusion, obtain a coordinate and a score of a bounding box of a detected target based on feature maps at each scale, and obtain a bounding box set R by filtering out bounding boxes with scores below a predetermined threshold; S4, cropping a corresponding image from the window image based on coordinates of bounding boxes in the bounding box set R, performing preprocessing on the corresponding image, and inputting the preprocessed corresponding image into a trained cell classification model, the cell classification model being configured to output a cell category of the corresponding image; and S5, obtaining a cell category of the nasal cytology to be diagnosed by postprocessing a cell in the corresponding image.

In a further aspect, a system for diagnosing a nasal cytology based on deep learning is provided, including: a reading module configured to read in blocks a nasal cytology to be diagnosed in a sliding window, an image read within a window being referred to as a window image; a preprocessing module configured to perform preprocessing on the window image; a cell detection module configured to input the preprocessed window image into a trained cell detection model, the cell detection model being configured to perform a series of feature extractions on the input preprocessed window image, enhance a pyramid feature map through bottom-up and top-down feature fusion, obtain a coordinate and a score of a bounding box of a detected target based on feature maps at each scale, and obtain a bounding box set R by filtering out bounding boxes with scores below a predetermined threshold; a cell classification module configured to crop a corresponding image from the window image based on coordinates of bounding boxes in the bounding box set R, perform preprocessing on the corresponding image, and input the preprocessed corresponding image into a trained cell classification model, the cell classification model being configured to output a cell category of the corresponding image; and a post-processing module configured to obtain a cell category of the nasal cytology to be diagnosed by post-processing a cell in the corresponding image.

Furthermore, an electronic device is provided, which includes a processor and memory. The memory stores at least one instruction, and at least one instruction is loaded and executed by the processor to perform the method for diagnose a nasal cytology based on deep learning.

Furthermore, a computer-readable storage medium with at least one instruction stored thereon was provided. At least one instruction is loaded and executed by a processor to perform the method for diagnose a nasal cytology based on deep learning.

The beneficial effects of the technical solution provided by the present disclosure include the following.

In the present study, the nasal cytology to be diagnosed is read in blocks in a sliding window, and an image is divided into a plurality of blocks for input into the deep learning model, thereby improving the diagnostic efficiency. Moreover, through the deep learning model of the present disclosure (to overcome the problems of large computational cost and poor real-time performance of the deep learning model, the present disclosure adopts an efficient improved real-time model for object detection (RTMDet) as the detection network and an improved MobileNetV3 as the classification network, instead of using the same network for detection and classification as in the prior art), it greatly improves the diagnostic efficiency of doctors, and has higher accuracy than the traditional methods.

### BRIEF DESCRIPTION OF DRAWINGS

To illustrate the technical solutions in the embodiments of the present disclosure more clearly, the following briefly introduces the drawings required for describing the embodiments. The drawings described below are only a few embodiments of the present disclosure. For ordinary skills in art, other drawings may also be obtained according to these drawings without creative efforts.

FIG. 1 shows a flowchart of a method for diagnosing a nasal cytology based on deep learning according to the embodiment of the present disclosure.

FIG. 2 shows a schematic of the improved RTMDet according to the embodiment of the present disclosure.

FIG. 3 shows a schematic diagram of the backbone network of an improved RTMDet according to the embodiment of the present disclosure.

FIG. 4 shows a schematic diagram of the neck network structure of an improved RTMDet according to the embodiment of the present disclosure.

FIG. 5 shows a schematic diagram of the spatial pyramid pooling efficient layer aggregation network-enhanced (SPPELAN-E) structure according to the embodiment of the present disclosure.

FIG. 6 shows a schematic diagram of an existing spatial pyramid pooling (SPP) structure.

FIG. 7 shows a schematic diagram of an efficient channel attention (ECA) mechanism according to the embodiment of the present disclosure.

FIG. 8 shows a schematic diagram of an improved MobileNetV3 according to the embodiment of the present disclosure.

FIG. 9 shows a schematic diagram of a MobileNetV3 bottle neck_EAC mechanism (bneck-E) structure according to the embodiment of the present disclosure.

FIG. 10 shows a schematic diagram of an existing MobileNetV3 bottle neck (bneck) structure.

FIG. 11 shows a schematic diagram of window cell deduplication according to the embodiment of the present disclosure.

FIG. 12 is a block diagram of a system for diagnosing a nasal cytology based on deep learning according to the embodiment of the present disclosure.

FIG. 13 shows a schematic structural diagram of the electronic device according to the embodiment of the present disclosure.

### DETAILED DESCRIPTION OF PREFERRED EMBODIMENTS

To clarify the technical problems, technical solutions, and advantages to be solved by the present disclosure, a detailed description will be provided below with reference to the accompanying drawings and specific embodiments.

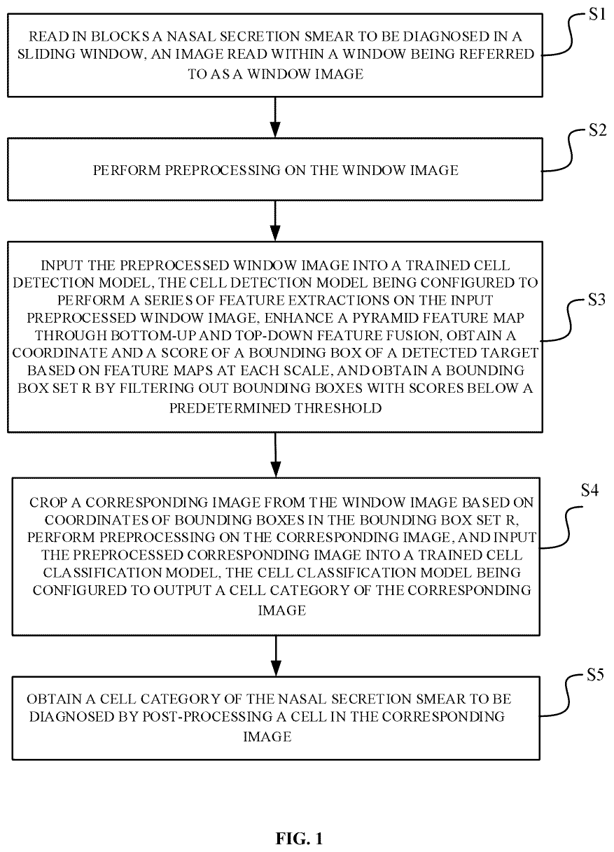

An embodiment of the present disclosure provides a method for diagnosing a nasal cytology based on deep learning, which may be implemented by an electronic device, and the electronic device may be a terminal or server. FIG. 1 shows a flowchart of the method for diagnosing nasal cytology based on deep learning. The processing flow of the method may include the following steps:

At block S1, the nasal cytology to be diagnosed is read in blocks in a sliding window; an image read within a window is referred to as a window image.

The image of the nasal cytology is extremely large, typically measuring 200,000×200,000 pixels (the effective physical area of the slide is approximately 50 mm×24 mm, and the cytology generally occupies half of this area, i.e., 24 mm×24 mm). The maximum power point (mpp) value of the imaging optical path is about 0.1 μm/pix=1e-4 mm/pix, yielding 24 mm/(1e-4 mm/pix)=240000 pixels). This image cannot be entirely loaded into memory; thus, block-wise reading is required. In the embodiment of the present disclosure, the data are read in blocks using a sliding window. The window size was 2048×2048, and the vertical and horizontal overlaps between the adjacent windows were 128. An image read within each window range is referred to as a window image.

At block S2, preprocessing is performed on the window image.

Optionally, preprocessing may include the following steps.

The window image is resized to the input size required by the cell detection model (in the embodiment of the present disclosure, the improved RTMDet requires the size of the input image to be 640×640, the window image is thus resized to this size).

Each pixel value in the image is subtracted by a predefined mean vector and then divided by a predefined standard deviation vector (in the embodiment of the present disclosure, the mean and standard deviation derived from a large public dataset ImageNet are adopted) to enable the pixel values in the image to be evenly distributed, thereby enhancing the subsequent model detection and classification.

Assuming that the window image is a uint8-type BGR image I with a size of 2048×2048×3, image I is first resized and then normalized to obtain image C=(I−(123.675, 116.28, 103.53))/(58.395, 57.12, 57.375), where (123.675, 116.28, 103.53) is the predefined mean vector, and (58.395, 57.12, 57.375) is the predefined standard deviation vector.

At block S3, the preprocessed window image is input into a trained cell detection model (The method for diagnosing a nasal cytology based on deep learning according to the embodiment of the present disclosure is a technology that analyzes and processes the scanned image of the nasal cytology using deep learning algorithms. By utilizing a large amount of scanned image data of nasal secretions, a large amount of annotated data of nasal secretion cells, and the powerful pattern recognition ability of deep learning algorithms, cell detection models, and cell classification models can be trained to automatically detect and identify cells such as neutrophils and eosinophils in nasal secretions, assisting doctors in disease diagnosis). The cell detection model performs a series of feature extractions on the input image, enhances a pyramid feature map through bottom-up and top-down feature fusion, obtains a coordinate and a score of a bounding box of a detected target based on feature maps at each scale, and obtains a bounding box set R by filtering out bounding boxes with scores below a predetermined threshold.

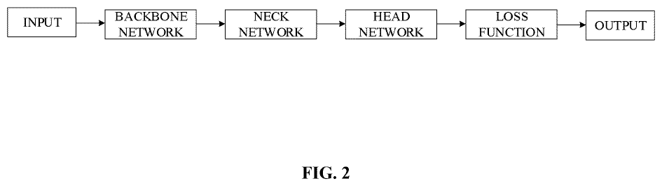

Optionally, as shown in FIG. 2, the cell detection model was based on an improved RTMDet network structure. The improved RTMDet includes the input, backbone network, neck network, head network, loss function, and the output.

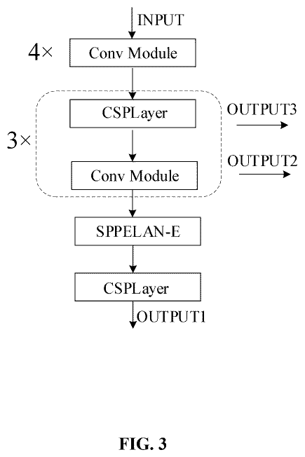

The input image was input into the backbone network. As shown in FIG. 3, the image first passes through four conventional (Conv) module structures to reduce the size and dimension while retaining the key features. Then, it passes through three cross-stage partial layer convolutional (CSPLayer-Conv) module composite structures to further extract key context features and generate two output feature maps (denoted as second output and third output) of different sizes for subsequent feature fusion. It then generates multiscale features through an improved SPPELAN-E spatial pyramid pooling structure to detect targets of different sizes. Finally, it extracts features through a cross-stage partial layer (CSPLayer) structure to enhance the performance of the model and generates a further output feature map (denoted as first output).

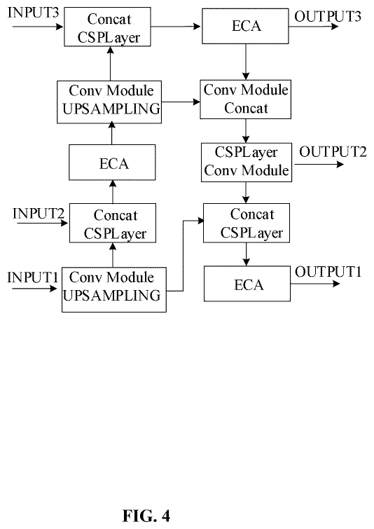

First output, second output, and third output are input into the neck network as inputs 1, 2, and 3, respectively. As shown in FIG. 4, input 1 is processed through a Conv Module structure and an upsampling operation to adjust its size and number of channels. It is then concatenated and fused with second input to enrich multi-scale information, followed by a CSPLayer structure to enhance feature representation. Owing to the small size, dense distribution, and adhesive nature of the nasal secretion target, noise may be generated during feature fusion, thereby affecting the quality of the final fused feature map. Thus, after each concatenation fusion and CSPLayer operation, an ECA mechanism is applied to suppress the fused noise and enhance attention to the nasal cytology. Then, the feature map is processed through a Conv Module structure and an upsampling operation to adjust its size and number of channels, concatenated and fused with third input to further enrich multi-scale information, followed by a CSPLayer structure to enhance feature representation. Subsequently, through an ECA mechanism, two branches are generated. One branch serves as third output of the neck network, and the other branch is adjusted in size through a Conv Module structure for downsampling and then further fused with the previously generated feature map to enrich more target information. It is then processed through a CSPLayer structure to enhance the feature representation, through a Conv Module structure for downsampling to adjust the size, and then further fused with the previously generated feature map to enrich more target information. Two branches were generated at this time. One branch serves as second output of the neck network, and the other branch is processed through a CSPLayer structure to enhance the feature representation and then through an ECA mechanism to output the first output.

In the head network part, the coordinates and scores of the bounding boxes of the target (the detected cell) are generated by performing decoding operations on outputs 1, 2, and 3 of the neck network through convolution modules.

Optionally, the loss function may include classification loss and bounding box regression loss. The classification loss can be expressed as

$$\begin{matrix}{loss}_{cls} = Quality Focal Loss \\ Focal Loss ( p ) = {{α}_{t} ( 1 - {p}_{t} )}^{γ} log ( {p}_{t} ) , {p}_{t} = \{ \begin{matrix}p , & when y = 1 \\ 1 - p , & when y = 0\end{matrix}\end{matrix}$$

where pₜ denotes a predicted probability of a true category of a sample, αₜ and γ denote adjustable weight parameters, y denotes an actual label of the sample, a scaling factor (1−pₜ)^{γ} of the Focal Loss being enable to reduce a proportion of simple categories in a loss and focus a model on difficult categories, at is configured to adjust a proportion between losses of positive samples and negative samples.

To address the inconsistency between the training and testing phases, the Quality Focal Loss combines the localization quality intersection-over-union (IOU) value with the classification score based on the Focal Loss. Because its label is a continuous value between 0 and 1, it has improved two parts of the Focal Loss, with the following formula:

$$Quality Focal Loss ( σ ) = - {\vert y - σ \vert}^{β} ( ( 1 - y ) log ( 1 - σ ) + y log ( σ ) )$$

where y denotes the actual label of the sample, σ denotes a label value obtained by combining the localization quality IOU value.

The bounding box regression loss adopts a generalized intersection over union (GIoU) loss and is configured to determine the relationship between overlapping areas of two boxes: the larger the overlapping area, the smaller the loss, and the smaller the overlapping area, the larger the loss. The GIoU loss is between [0, 2], and its value being limited to a small range, enabling a network to avoid severe fluctuations and maintain better stability, and the GIoU loss is expressed by:

$$\begin{matrix}IOU = \frac{A ⋂ B}{A ⋃ B} \\ GIOU = IOU - \frac{\vert C - ( A ⋃ B ) \vert}{\vert C \vert} \\ GIOU Loss = 1 - GIOU\end{matrix}$$

where A and B denote the two bounding boxes, C denotes the smallest bounding box enclosing the two bounding boxes, and IOU denotes the intersection-over-union of A and B.

In contrast, the improved spatial pyramid pooling structure SPPELAN-E is configured to enable the network to process input images of different sizes without mandatory cropping or resizing of the input images to reduce information loss and improve model performance.

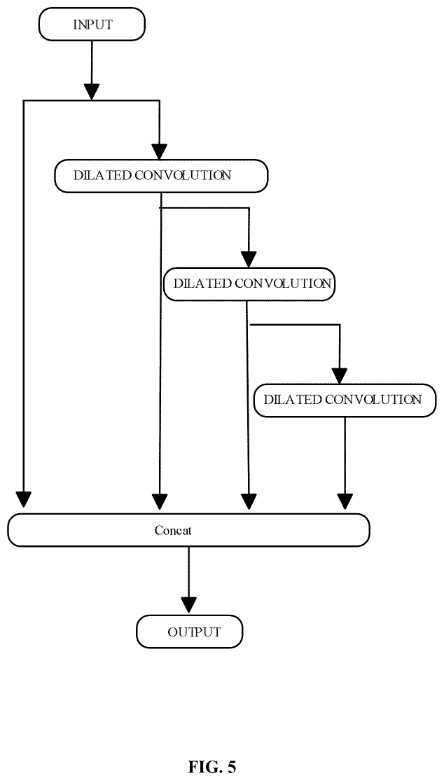

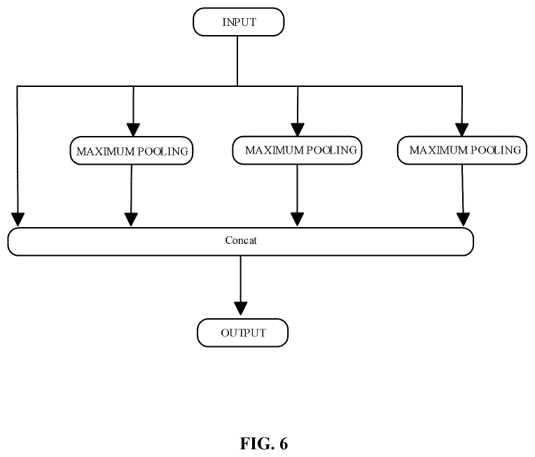

As shown in FIG. 5, SPPELAN-E retains one of the four branches of an existing SPP structure (as shown in FIG. 6, the existing SPP structure performs four different operations on the four input branches: one branch is retained without any changes, the other three branches undergo maximum pooling operations of different sizes to generate feature maps of different sizes, and finally, the output results of the four different branches are concatenated to form the final output). It utilizes a dilated convolution to expand the receptive field and adds a residual structure to the output such that the input of the remaining branches is derived from the output of the preceding branch. While expanding the receptive field, it also enhanced the feature expression of the model. Finally, the outputs of the four branches are concatenated to form the final output.

Compared with the existing SPP structure, the SPPELAN-E in the embodiment of the present disclosure retains more semantic information and has better performance in detecting small targets such as nasal secretions. This is because the SPP structure uses maximum pooling operations multiple times, and this operation only takes the maximum value of each element and ignores other elements, leading to the loss of useful information in some feature mappings. However, dilated convolution expands the receptive field by introducing a dilation factor, without losing useful information. In addition, a continuous residual structure may retain effective information.

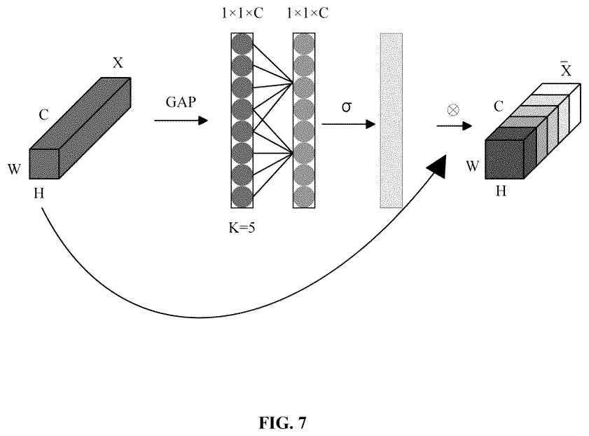

Optionally, as shown in FIG. 7 (where X represents the input feature map, W represents the width of the feature map, H represents the height of the feature map, C represents the number of channels of the feature map, K represents the size of the convolution kernel used to calculate the attention weight of each channel, and @ represents the sigmoid activation function), the ECA mechanism first compresses the spatial dimension of the input feature map to 1 while keeping the number of channels of the input feature map unchanged.

Second, local cross-channel interaction information is obtained through a one-dimensional convolution with size K. The non-dimensionality-reduction local cross-channel interaction strategy enables effective interaction between channels while maintaining inter-channel correlations to improve the expressive power and performance of a network.

Subsequently, a channel attention weight is generated by processing an output through a sigmoid activation function, enabling the output to be between 0 and 1.

Finally, a final feature map is obtained by multiplying the channel attention weight by the input feature map.

Because ECA may capture the relationships between different channels, thereby enhancing the ability of feature representation, using this mechanism, the embodiment of the present disclosure may effectively enhance the representation ability of the network without increasing excessive parameters and computational costs, thus improving the accuracy of nasal secretion diagnosis.

At block S4, a corresponding image is cropped from the window image based on the coordinates of the bounding boxes in the bounding box set R, preprocessing is performed on the corresponding image, and the corresponding image is input into a trained cell classification model, which is configured to output a cell category of the corresponding image.

The image cropped in the embodiment of the present disclosure does not have bounding boxes (i.e., the image cropped from the original image according to the coordinates of the bounding box). Each image included only one cell (the number of images was equal to the number of detected cells, with one cell in each image). The cell classification model classified each cell. Specifically, a bounding box r=(x, y, w, h) is sequentially taken from set R, and image A is obtained by cropping bounding box r from the original window image I. Image A was resized to a size×224×224 (the size required for the input image by the improved MobileNetV3 of the cell classification model) to obtain image B. The image B is normalized to obtain the image D=(B−(123.675, 116.28, 103.53))/(58.395, 57.12, 57.375). Image D was inputted into the improved MobileNetV3 of the cell classification model, and the scores of the three categories (eosinophils, neutrophils, and other cells) were obtained. The category corresponding to the highest score among the scores output by the model was selected as the cell category.

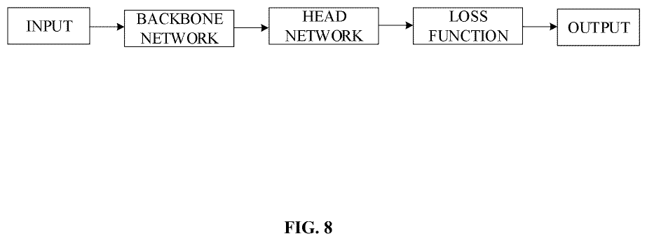

Optionally, as shown in FIG. 8, the cell classification model is based on an improved MobileNetV3, which includes the input, backbone network, head network, loss function, and output.

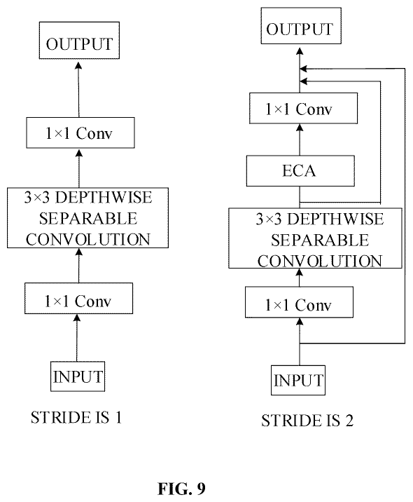

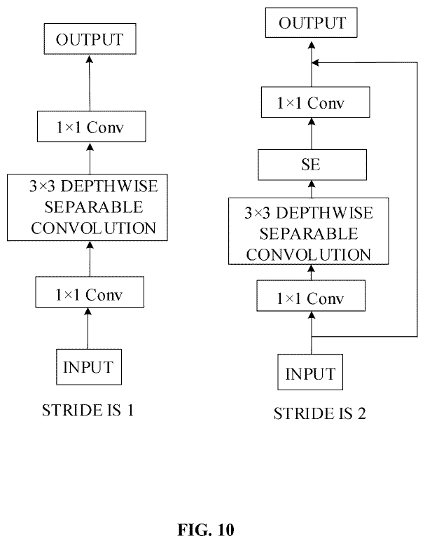

The input image was input into the backbone network for feature extraction. As shown in FIG. 9, the backbone network of the improved MobileNetV3 includes multiple bneck-E structures. For a plurality of bneck structures in the backbone network of an existing MobileNetV3 (as shown in FIG. 10), the backbone network of the existing MobileNetV3 has multiple bneck structures. When the stride is one, the feature map first passes through a 1×1 convolution to expand the number of channels, followed by a depthwise separable convolution to reduce the model parameters while performing feature extraction. Finally, a further 1×1 convolution is used to restore the original number of channels. When the stride was two, the feature map passed through the two branches. The main branch is similar to that when the stride is 1, except that an squeeze-and-excitation (SE) attention mechanism is added after the depthwise separable convolution to enhance the expression of key features, and the result is added to the other branch to avoid gradient explosion and improve the model performance. However, for nasal secretion images, due to differences in staining and smear techniques, the existing network cannot extract key features), and no modification is made when the stride is 1. In a bneck structure with a stride of two, the SE attention mechanism (similar to the ECA mechanism, but using fully connected layers when obtaining channel information, which increases computational efficiency) is replaced with an ECA mechanism to improve the computational efficiency and reduce the number of parameters. In addition, a branch is added after depthwise separable convolution to enhance the network performance.

After feature extraction, the process proceeds to the head network, which includes several convolutional layers and fully connected layers to determine the classification loss value of the extracted feature map and finally outputs the cell classification result (the output cell categories include eosinophils, neutrophils, and other cells).

Optionally, the loss function adopts a cross-entropy loss and is expressed as follows:

$$L ( p , y ) = - log ( {p}_{t} ) , {p}_{t} = \{ \begin{matrix}p , & y = 1 \\ 1 - p , & otherwise\end{matrix}$$

where p denotes a predicted probability of a sample in a category, and y denotes a sample label.

At block S5, a cell category of the nasal cytology to be diagnosed was obtained by post-processing a cell in the corresponding image.

The post-processing may include: mapping a coordinate of a cell, detected in the window image, with a top-left corner of the window as an origin to an original image, assuming the coordinate of the cell is r=(x, y, w, h) and a coordinate of the top-left corner of the window is (l, t), determining the coordinate of the cell in the original image as (x+l, y+t, w, h); removing duplicate cells in an overlapping area of the sliding window, determining an IOU value between a cell and all cells detected in an adjacent window, and considering two cells as a same cell in accordance with the IOU value of the two cells being greater than 0.5.

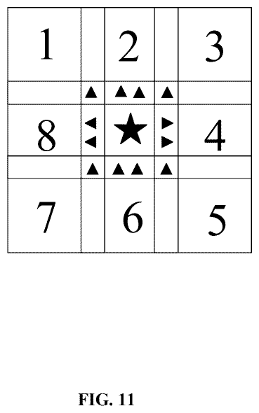

FIG. 11 is a scheme diagram of cell deduplication. As shown in FIG. 11, the central area represents the cell in the current window, and the triangular areas represent the overlapping cells with the adjacent 8 windows. Therefore, to remove duplicate cells, it is necessary to calculate the IOU value for each cell in the surrounding eight windows to achieve deduplication.

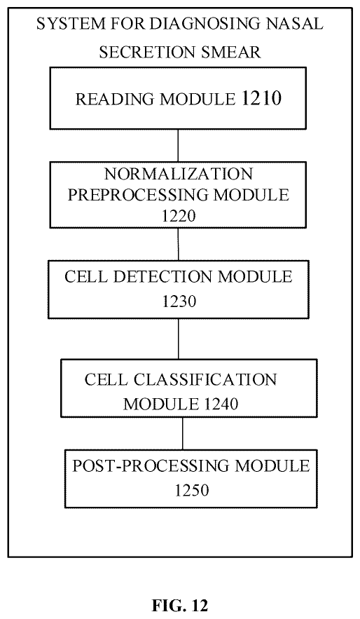

As shown in FIG. 12, the present disclosure further provides a system for diagnosing a nasal cytology based on deep learning, including reading module 1210, preprocessing module 1220, cell detection module 1230, cell classification module 1240, and post-processing module 1250.

Reading module 1210 is configured to read a nasal cytology in blocks to be diagnosed in a sliding window, and an image read within a window is referred to as a window image.

The preprocessing module 1220 was configured to perform preprocessing on the window image.

The cell detection module 1230 was configured to input the preprocessed window image into the trained cell detection model. The cell detection model is configured to perform a series of feature extractions on the input preprocessed window image, enhance a pyramid feature map through bottom-up and top-down feature fusion, obtain a coordinate and score of a bounding box of a detected target based on feature maps at each scale, and obtain a bounding box set R by filtering out bounding boxes with scores below a predetermined threshold.

The cell classification module 1240 is configured to crop a corresponding image from the window image based on the coordinates of the bounding boxes in the bounding box set R, perform Preprocessing is performed on the corresponding image, and the corresponding image is input into a trained cell classification model, which is configured to output a cell category of the corresponding image.

The post-processing module 1250 was configured to obtain a cell category of the nasal cytology to be diagnosed by post-processing a cell in the corresponding image.

The system for diagnosing a nasal cytology based on deep learning provided in the embodiment of the present disclosure may have functional structures corresponding to the method for diagnosing a nasal cytology based on deep learning provided in the embodiment of the present disclosure and will not be repeated here.

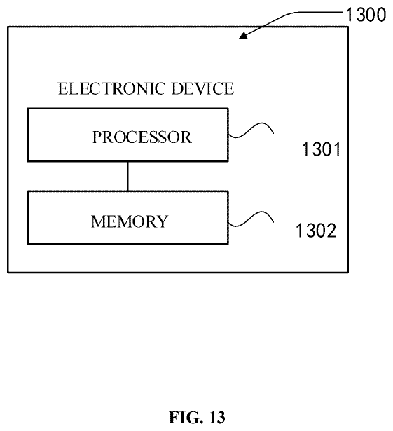

FIG. 13 shows a schematic structural diagram of electronic device 1300 provided in an embodiment of the present disclosure. Electronic device 1300 may have relatively large differences due to different configurations or performances, and may include one or more central processing units (CPUs) 1301 and one or more memories 1302. Memory 1302 stores at least one instruction, and at least one instruction is loaded and executed by processor 1301 to implement the aforementioned method for diagnosing a nasal cytology based on deep learning.

In an example embodiment, a computer-readable storage medium is provided, such as memory, including instructions. The above instructions can be executed by a processor in a terminal to complete the method for diagnosing a nasal cytology based on deep learning. For example, computer-readable storage media may include ROM, random access memory (RAM), CD-ROM, magnetic tape, floppy disks, and optical data storage devices.

Those of ordinary skill in the art can understand that all or part of the steps in the above embodiments can be implemented by hardware or by a program instructing relevant hardware to complete. The program can be stored on a computer-readable storage medium. The above-mentioned storage medium can be a read-only memory, magnetic disk, or optical disk.

The above descriptions are the only preferred embodiments of the present disclosure and are not intended to limit the present disclosure. Any modification, equivalent replacement, improvement, etc., made within the spirit and principles of the present disclosure shall be included in the protection scope of the present disclosure.

What is claimed is:

1. A method for diagnosing nasal cytology based on deep learning, comprising:
S1, reading in blocks a nasal cytology to be diagnosed in a sliding window, an image read within a window being referred to as a window image;
S2, performing preprocessing on the window image;
S3, inputting the preprocessed window image into a trained cell detection model, the cell detection model being configured to perform a series of feature extractions on the input preprocessed window image, enhance a pyramid feature map through bottom-up and top-down feature fusion, obtain a coordinate and a score of a bounding box of a detected target based on feature maps at each scale, and obtain a bounding box set R by filtering out bounding boxes with scores below a predetermined threshold;
S4, cropping a corresponding image from the window image based on coordinates of bounding boxes in the bounding box set R, performing preprocessing on the corresponding image, and inputting the preprocessed corresponding image into a trained cell classification model, the cell classification model being configured to output a cell category of the corresponding image; and
S5, obtaining a cell category of the nasal cytology to be diagnosed by post-processing a cell in the corresponding image;
wherein the cell detection model is based on an improved real-time model for object detection (RTMDet) network structure, and the improved RTMDet network structure comprises input, a backbone network, a neck network, a head network, a loss function, and output;
the input preprocessed window image being input into the backbone network to reduce a size while retaining key features of the input preprocessed window image through four convolutional (Conv) module structures, generate two output feature maps, denoted as a second output and a third output, of different sizes for subsequent feature fusion by further extracting key context features through three cross-stage partial layer convolutional (CSPLayer-Conv) module composite structures, generate multi-scale features through an improved spatial pyramid pooling structure spatial pyramid pooling efficient layer aggregation network-enhanced (SPPELAN-E) for detecting targets of different sizes, and generate an output feature map, denoted as a first output, by further extracting features through a cross-stage partial layer (CSPLayer) structure,
the first output, the second output and the third output being input into the neck network as an input 1, a second input, and a third input respectively, wherein the input 1 is processed through the Conv module structure and an upsampling operation to adjust its size and a number of channels, then concatenated and fused with the second input to enrich multi-scale information, followed by the CSPLayer structure to enhance feature representation, considering small size, dense distribution and adhesive nature of a nasal secretion target, many noises being generated during feature fusion, affecting a quality of a final fused feature map, after each concatenation fusion and a CSPLayer operation, an efficient channel attention (ECA) mechanism being applied to suppress a fused noise and enhance attention to the nasal cytology, a feature map is processed through the Conv module structure and an upsampling operation to adjust a size and a number of channels of the feature map, then concatenated and fused with the third input for further enriching multi-scale information, and followed by the CSPLayer structure to enhance feature representation;
wherein the ECA mechanism is applied, and two branches are generated with one serving as a third output of the neck network, and the other is adjusted in size through the Conv module structure for downsampling and fused with a previously generated feature map to enrich target information;
wherein the CSPLayer structure is applied to enhance the feature representation, and the Conv module structure is applied for downsampling to adjust the size, and further fusion with a previously generated feature map is performed to enrich more target information; two branches are generated with one serving as a second output of the neck network, and the other is processed through the CSPLayer structure to enhance the feature representation, followed by the ECA mechanism to output the first output;
wherein in the head network, the coordinates and scores of the bounding boxes of a target are generated by performing decoding operations on the first output, the second output, and the third output of the neck network using convolution modules;
wherein the cell classification model is based on an improved MobileNetV3, comprising input, a backbone network, a head network, a loss function, and output;
wherein an input image is input into the backbone network for feature extraction, the backbone network of the improved MobileNetV3 comprises a plurality of bottle neck_EAC mechanism (bneck-E) structures, for a plurality of bottle neck (bneck) structures of a backbone network of an existing MobileNetV3, no modification is made in accordance with a stride of 1, an squeeze-and-excitation (SE) attention mechanism is replaced with an ECA mechanism in the bneck structure with a stride of 2 to improve computational efficiency and reduce a number of parameters, a branch is added after a depthwise separable convolution to enhance network performance;
the head network, comprising convolutional layers and a fully connected layer, is applied after the feature extraction to determine a classification loss of an extracted feature map and output a cell classification result.

2. The method of claim 1, wherein the preprocessing includes:
resizing the window image to an input size required by the cell detection model; and
normalizing the resized image by subtracting a predefined mean vector from each pixel value in the resized image and then dividing by a predefined standard deviation vector to enable pixel values in the resized image to be evenly distributed.

3. The method of claim 1, wherein the loss function comprises a classification loss and a bounding box regression loss,
wherein the classification loss is expressed by:
$$\begin{matrix}{loss}_{cls} = Quality Focal Loss \\ Focal Loss ( p ) = {{α}_{t} ( 1 - {p}_{t} )}^{γ} log ( {p}_{t} ) , {p}_{t} = \{ \begin{matrix}p , & when y = 1 \\ 1 - p , & when y = 0\end{matrix}\end{matrix}$$
pₜ denoting a predicted probability of a true category of a sample, αₜ and γ denoting adjustable weight parameters, y denoting an actual label of the sample, a scaling factor (1−pₜ)^{γ} of the Focal Loss being enable to reduce a proportion of simple categories in a loss and focus a model on difficult categories, αₜ being configured to adjust a proportion between losses of positive samples and negative samples;
Quality Focal Loss combining a localization quality intersection-over-union (IOU), value with a classification score based on the Focal Loss, a label of the quality focal loss being a continuous value between 0 and 1, and the quality focal loss being expressed by improving two parts of the Focal Loss:
$$Quality Focal Loss ( σ ) = - {\vert y - σ \vert}^{β} ( ( 1 - y ) log ( 1 - σ ) + y log ( σ ) )$$
y denoting the actual label of the sample, σ denoting a label value obtained by combining the localization quality IOU value;
the bounding box regression loss adopting a generalized intersection over union (GIoU) loss, and being configured to determine a relationship between overlapping areas of two boxes, a larger overlapping area corresponding to a smaller GIoU loss, and a smaller overlapping area corresponding to a larger GIoU loss, the GIoU loss being between [0, 2], and its value being limited to a small range, enabling a network to avoid severe fluctuations and maintain better stability, and the GIoU loss being expressed by:
$$\begin{matrix}IOU = \frac{A ⋂ B}{A ⋃ B} \\ GIOU = IOU - \frac{\vert C - ( A ⋃ B ) \vert}{\vert C \vert} \\ GIOU Loss = 1 - GIOU\end{matrix}$$
wherein A and B denote two bounding boxes, C denotes a smallest bounding box enclosing the two bounding boxes, and IOU denotes an intersection-over-union of A and B.

4. The method of claim 1, wherein the improved spatial pyramid pooling structure SPPELAN-E is configured to enable a network to process input images of different sizes without mandatory cropping or resizing of the input images to reduce information loss and improve model performance;
wherein the SPPELAN-E retains one of four branches from a spatial pyramid pooling, SPP, structure, expanding a receptive field by using a dilated convolution, and a residual structure being applied to an output, inputs of remaining branches are derived from an output of a preceding branch, the receptive field being expanded, feature expression of the model being enhanced, and outputs from four different branches being concatenated into a final output.

5. The method of claim 1, wherein the ECA mechanism first compresses a spatial dimension of an input feature map to 1 while keeping a number of channels of the input feature map unchanged,
wherein local cross-channel interaction information is obtained through a one-dimensional convolution with size K, and a non-dimensionality-reduction local cross-channel interaction strategy enables effective interaction between channels while maintaining inter-channel correlations to improve the expressive power and performance of a network;
wherein a channel attention weight is generated by processing an output through a sigmoid activation function, enabling the output to be between 0 and 1;
wherein a final feature map is obtained by multiplying the channel attention weight.

6. The method of claim 1, wherein the loss function adopts a cross-entropy loss, and is expressed as
$$L ( p , y ) = - log ( {p}_{t} ) , {p}_{t} = \{ \begin{matrix}p , & y = 1 \\ 1 - p , & otherwise\end{matrix}$$
p denoting a predicted probability of a sample in a category, and y denoting a sample label.

7. The method of claim 1, wherein the post-processing comprises:
mapping a coordinate of a cell, detected in the window image, with a top-left corner of a window as an origin to an original image, assuming the coordinate of the cell is r=(x, y, w, h) and a coordinate of the top-left corner of the window is (l, t), determining the coordinate of the cell in the original image as (x+l, y+t, w, h);
removing duplicate cells in an overlapping area of the sliding window, determining an quality intersection-over-union (IOU) value between a cell and all cells detected in an adjacent window, and considering two cells as a same cell in accordance with the IOU value of the two cells being greater than 0.5.
